(19) United States
(12) Patent Application Publication
(10) Pub. No.: US 2009/0085548 A1
(43) Pub. Date: Apr. 2, 2009

(54) CONVERTER CIRCUIT AND METHOD FOR OPERATING SUCH A CONVERTER CIRCUIT

(75) Inventors: Yongsug Suh, Jeonju (KR); Peter Steimer, Ehrendingen (CH); Oliver Keiser, Kriens (CH)

Correspondence Address: BUCHANAN, INGERSOLL & ROONEY PC, POST OFFICE BOX 1404, ALEXANDRIA, VA, 22313-1404, US

(73) Assignee: ABB Schweiz AG, Baden (CH)

(21) Appl. No.: 12/210,392

(22) Filed: Sep. 15, 2008

(30) Foreign Application Priority Data
Sep. 27, 2007 (EP) 07117325.6

(51) Int. Cl. G05F 3/02

(52) U.S. Cl. 323/304

(57) ABSTRACT

A converter circuit is specified in which, in order to avoid losses to the greatest possible extent, a first inductance is connected in series into the connection of a DC voltage source of the converter circuit to a first switch of the converter circuit, and in which, moreover, a second inductance is connected in series into the connection of a second switch of a switching group of the converter circuit to the junction point between a second capacitive energy store and a second unidirectional non-drivable power semiconductor switch of the switching group. Two further alternative converter circuits and also a method for operating the converter circuit are furthermore specified.

### RELATED APPLICATION

This application claims priority under 35 U.S.C. §119 to European Patent Application No. 07117325.6 filed in Europe on Sep. 27, 2007, the entire content of which is hereby incorporated by reference in its entirety.

### TECHNICAL FIELD

The disclosure relates to the field of power electronics circuits. It is based on a converter circuit and also a method for operating said converter circuit.

### BACKGROUND INFORMATION

Converter circuits are used nowadays in a wealth of power electronic applications. The use of a converter circuit is conceivable for example as a DC-DC converter, in particular step-down converter. Such a customary converter circuit, in particular a DC-DC converter, is shown for example in FIG. 1 in accordance with “A new approach to reducing output ripple in switched-capacitor-based Step-down DC-DC converters”, IEEE Transactions on Power Electronics, Vol. 21, No. 6, November 2006. According to FIG. 1, the converter circuit has a DC voltage source and a first switch which is connected to the DC voltage source. Furthermore, the converter circuit comprises a switching group, which switching group has a second switch, a first capacitive energy store, a first and a second unidirectional non-drivable power semiconductor switch, wherein the second switch is connected to the first capacitive energy store, the first capacitive energy store is connected to the first unidirectional non-drivable power semiconductor switch and the second unidirectional non-drivable power semiconductor switch is connected to the junction point between the first capacitive energy store and the first unidirectional non-drivable power semiconductor switch. Furthermore, the converter circuit in accordance with FIG. 1 comprises a second capacitive energy store, which second capacitive energy store is connected jointly to the second switch of the switching group and to the second unidirectional non-drivable power semiconductor switch of the switching group. The second capacitive energy store is additionally connected to the first unidirectional non-drivable power semiconductor switch of the switching group and the DC voltage source is connected to the junction point between the second capacitive energy store and the first unidirectional non-drivable power semiconductor switch of the switching group.

If the first switch is now closed and the second switch is opened, then the first capacitive energy store is charged by the DC voltage source, as a result of which high losses arise during the charging process, however. The charging of a capacitive energy store from 0 V to the voltage value of the DC voltage source inherently has for example an efficiency of only 50%. High losses likewise arise during the discharging of the first capacitive energy store, that is to say when the first switch is closed and the second switch is opened. Overall, the losses of the energy transfer between the capacitive energy stores for applications with demands for a high efficiency are thus unacceptable.

### SUMMARY

Exemplary embodiments disclosed herein can embody and operate a converter circuit of the type mentioned in the introduction in such a way that as far as possible no losses occur.

A converter circuit is disclosed having a DC voltage source, having a first switch, which is connected to the DC voltage source, having a switching group, which switching group has a second switch, a first capacitive energy store, a first and a second unidirectional non-drivable power semiconductor switch, wherein the second switch is connected to the first capacitive energy store, the first capacitive energy store is connected to the first unidirectional non-drivable power semiconductor switch, the second unidirectional non-drivable power semiconductor switch is connected to the junction point between the first capacitive energy store and the first unidirectional non-drivable power semiconductor switch and the first switch is connected to the junction point between the second switch and the first capacitive energy store, having a second capacitive energy store, which second capacitive energy store is connected jointly to the second switch of the switching group and to the second unidirectional non-drivable power semiconductor switching of the switching group, the second capacitive energy store is connected to the first unidirectional non-drivable power semiconductor switch of the switching group and the DC voltage source is connected to the junction point between the second capacitive energy store and the first unidirectional non-drivable power semiconductor switch of the switching group, wherein a first inductance is connected in series into the connection of the DC voltage source to the first switch, and wherein a second inductance is connected in series into the connection of the second switch of the switching group to the junction point between the second capacitive energy store and the second unidirectional non-drivable power semiconductor switch of the switching group.

A converter circuit is disclosed having a DC voltage source, having a first switch, which is connected to the DC voltage source, having a switching group and n further switching groups, wherein n≧1 and each switching group has a second switching, a first capacitive energy store, a first and a second unidirectional non-drivable power semiconductor switch, wherein the second switch is connected to the first capacitive energy store, the first capacitive energy store is connected to the first unidirectional non-drivable power semiconductor switch, the second unidirectional non-drivable power semiconductor switch is connected to the junction point between the first capacitive energy store and the first unidirectional non-drivable power semiconductor switch, the first switch is connected to the junction point between the second switch and the first capacitive energy store of the switching group each of the n further switching groups is connected in interlinked fashion to the respectively adjacent further switching group and the switching group is connected in interlinked fashion to the first further switching group, wherein the first unidirectional non-drivable power semiconductor switches of the switching groups are connected to one another, having a second capacitive energy store, which second capacitive energy store is jointly connected to the second switch of the n-th further switching group and to the second unidirectional non-drivable power semiconductor switch of the n-th further switching group, the second capacitive energy store and the DC voltage source are connected to the junction point between the first unidirectional non-drivable power semiconductor switches of the switching groups, wherein a first inductance is connected in series into the connection of the DC voltage source to the first switch, and wherein a second inductance is connected in series into the connection of the second switch of the n-th further switching group to the junction point between the second capacitive energy store and the second unidirectional non-drivable power semiconductor switch of the n-th further switching group.

A converter circuit is disclosed having a DC voltage source, having a first switch, which is connected to the DC voltage source, having a switching group and n further switching groups, wherein n≧1 and each switching group has a second switch, a first capacitive energy store, a first and a second unidirectional non-drivable power semiconductor switch, wherein the second switch is connected to the first capacitive energy store, the first capacitive energy store is connected to the first unidirectional non-drivable power semiconductor switch, the second unidirectional non-drivable power semiconductor switch is connected to the junction point between the first capacitive energy store and the first unidirectional non-drivable power semiconductor switch, the first switch is connected to the junction point between the second switch and the first capacitive energy store of the switching group, each of the n further switching groups is connected in interlinked fashion to the respectively adjacent further switching group and the switching group is connected in interlinked fashion to the first further switching group, wherein the first unidirectional non-drivable power semiconductor switches of the switching groups are connected to one another, having a second capacitive energy store, which second capacitive energy store is jointly connected to the second switch of the n-th further switching group and to the second unidirectional non-drivable power semiconductor switch of the n-th further switching group, the second capacitive energy store and the DC voltage source are connected to the junction point between the first unidirectional non-drivable power semiconductor switches of the switching groups, wherein a first inductance is connected in series into the connection of the DC voltage source to the first switch, and wherein a second inductance is connected in series into the connection of the second capacitive energy store to the junction point between the second switch of the n-th further switching group and the second unidirectional non-drivable power semiconductor switch of the n-th further switching group.

In another aspect, a converter circuit having a DC voltage source is disclosed, comprising: a first switch of the converter circuit; a first inductance connected in series into a connection of the DC voltage source of the converter circuit to the first switch of the converter circuit; a switching group of the converter circuit having a second switch, a second capacitive energy store, and a second unidirectional non-drivable power semiconductor switch; and a second inductance connected in series into a connection of the second switch of the switching group of the converter circuit to a junction point between the second capacitive energy store and the second unidirectional non-drivable power semiconductor switch of the switching group.

These and further objects, advantages and features of the present disclosure will become apparent from the following detailed description of exemplary embodiments of the disclosure in conjunction with the drawing.

### BRIEF DESCRIPTION OF THE DRAWINGS

In the figures:

FIG. 1 shows an embodiment of a known converter circuit,

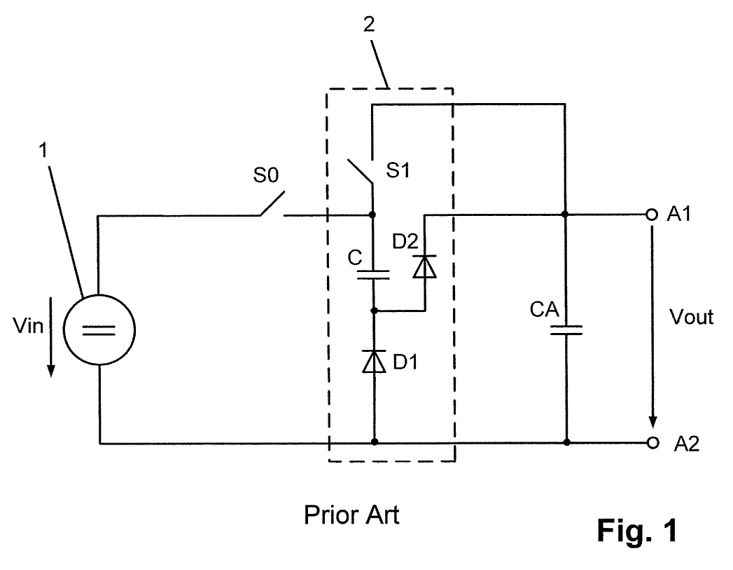

FIG. 2 shows a first exemplary embodiment of a converter circuit according to the disclosure,

FIG. 3 shows a second exemplary embodiment of the converter circuit according to the disclosure, and

FIG. 4 shows a third exemplary embodiment of the converter circuit according to the disclosure.

The reference symbols used in the drawing and their meaning are summarized in the list of reference symbols. In principle, identical parts are provided with identical reference symbols in the figures. The embodiments described represent examples of the subject matter of the disclosure and have no restrictive effect.

### DETAILED DESCRIPTION

The converter circuit according to the disclosure has a DC voltage source and a first switch, which is connected to the DC voltage source. Furthermore, the converter circuit comprises a switching group, which switching group has a second switch, a first capacitive energy store, a first and second unidirectional non-drivable power semiconductor switch, wherein the second switch is connected to the first capacitive energy store, the first capacitive energy store is connected to the first unidirectional non-drivable power semiconductor switch, the second unidirectional non-drivable power semiconductor switch is connected to the junction point between the first capacitive energy store and the first unidirectional non-drivable power semiconductor switch and the first switch is connected to the junction point between the second switch and the first capacitive energy store. Furthermore, the converter circuit comprises a second capacitive energy store, which second capacitive energy store is connected jointly to the second switch of the switching group and to the second unidirectional non-drivable power semiconductor switch of the switching group. The second capacitive energy store is additionally connected to the first unidirectional non-drivable power semiconductor switch of the switching group and the DC voltage source is connected to the junction point between the second capacitive energy store and the first unidirectional non-drivable power semiconductor switch of the switching group. According to the disclosure, a first inductance is now connected in series into the connection of the DC voltage source to the first switch. Furthermore, a second inductance is connected in series into the connection of the second switch of the switching group to the junction point between the second capacitive energy store and the second unidirectional non-drivable power semiconductor switch of the switching group.

If the first capacitive energy store is now charged by closing the first switch and opening the second switch, then advantageously virtually no losses arise, since the first inductance together with the first capacitive energy store forms a resonant circuit having a resonant behavior. Moreover, the first capacitive energy store is charged to double the voltage value of the DC voltage source, such that an improved utilization of the first capacitive energy store can advantageously be achieved. If the first capacitive energy store is discharged when the first switch is opened and the second switch is closed, then in that case, too, advantageously virtually no losses arise, since the second inductance together with the first and second capacitive energy stores forms a resonant circuit having a resonant behavior.

According to the disclosure, during the operation of the converter circuit with the one switching group, in terms of the method, firstly, for an adjustable first time period, the first switch is closed and the second switch is opened, whereby it can advantageously be ensured that the first capacitive energy store is charged to double the voltage value of the DC voltage source sufficiently and without appreciable losses. After the adjustable first time period has elapsed, then, for an adjustable second time period, the first switch is opened and the second switch is closed, whereby the first capacitive energy store is discharged to a certain extent via the second inductance depending on the setting of the second time period and the second capacitive energy store is charged. After the second time period has elapsed, the steps mentioned above are then repeated. Overall, what can be achieved by this operation in a very simple manner is that almost no losses occur and an electrical load connected for example to the second capacitive energy store can always be supplied sufficiently with electrical energy and a stable voltage value.

As an alternative, the converter circuit according to the disclosure comprises the switching group and additionally n further switching groups, wherein n≧1 and each switching group has the second switch, the first capacitive energy store, the first and the second unidirectional non-drivable power semiconductor switch, wherein the second switch is connected to the first capacitive energy store, the first capacitive energy store is connected to the first unidirectional non-drivable power semiconductor switch, the second unidirectional non-drivable power semiconductor switch is connected to the junction point between the first capacitive energy store and the first unidirectional non-drivable power semiconductor switch and the first switch is connected to the junction point between the second switch and the first capacitive energy store of the switching group. Each of the n further switching groups is connected in interlinked fashion to the respectively adjacent further switching group and the switching group is connected in interlinked fashion to the first further switching group, wherein the first unidirectional non-drivable power semiconductor switches of the switching groups are connected to one another. Furthermore, the converter circuit comprises the second capacitive energy store, which second capacitive energy store is jointly connected to the second switch of the n-th further switching group and to the second unidirectional non-drivable power semiconductor switch of the n-th further switching group, and the second capacitive energy store and the DC voltage source are connected to the junction point between the first unidirectional non-drivable power semiconductor switches of the switching groups. According to the disclosure, in this alternative converter circuit, too, the first inductance is connected in series into the connection of the DC voltage source to the first switch. Moreover, now the second inductance is connected in series into the connection of the second switch of the n-th further switching group to the junction point between the second capacitive energy store and the second unidirectional non-drivable power semiconductor switch of the n-th further switching group or the second inductance is connected in series into the connection for the second capacitive energy store to the junction point between the second switch of the n-th further switching group and the second unidirectional non-drivable power semiconductor switch of the n-th further switching group.

By closing the first switch and opening the second switches of all the switching groups, the first capacitive energy store of each switching group is charged, wherein advantageously virtually no losses arise, since the first inductance together with the first capacitive energy stores of the switching groups forms a resonant circuit having a resonant behavior. Moreover, the first capacitive energy stores are charged to double the voltage value of the DC voltage source, such that an improved utilization of the first capacitive energy stores can advantageously be achieved. If, when the first switch is opened and at least one of the second switches of the switching groups is closed, the associated first capacitive energy store is discharged, then in that case, too, advantageously virtually no losses arise, since the second inductance together with the first and second capacitive energy stores or, in the case of a plurality of closed second switches, with the corresponding first capacitive energy stores and the second capacitive energy store forms a resonant circuit having a resonant behavior. Moreover, by flexibly closing at least one second switch of the switching groups, the voltage at the second capacitive energy store can advantageously be set, to which second capacitive energy store an electrical load can be connected, in particular in parallel.

According to the disclosure, during the operation of the converter circuit with the one switching group and the n further switching groups, in terms of the method, firstly, for an adjustable first time period, the first switch is closed and the second switches are opened, whereby it can advantageously be ensured that all of the first capacitive energy stores of the switching groups are charged to double the voltage value of the DC voltage source sufficiently and without appreciable losses. After the adjustable first time period has elapsed, the first switch is then opened and kept opened, wherein likewise after the adjustable first time period has elapsed, at least one of the second switches is closed for an adjustable second time period. After the adjustable second time period has elapsed, the at least one second switch that was previously closed is opened and kept opened, wherein likewise after the adjustable second time period has elapsed, at least one second switch that has not yet been closed previously is closed for the adjustable second time period. After the adjustable second time period has elapsed, the at least one second switch that was previously closed is opened and kept opened. These steps mentioned above are repeated until all of the second switches have been closed and opened again once. Afterward, all the steps are then repeated again from the beginning. By closing at least one of the second switches, the first capacitive energy store or the first capacitive energy stores is or are discharged to a certain extent via the second inductance depending on the setting of the second time period and the second capacitive energy store is charged. Furthermore, by means of the above-described flexible closing of at least one second switch of the switching groups, it is advantageously possible to set the voltage at the second capacitive energy store and thus optimally supply an electrical load connected for example to the second capacitive energy store.

As an alternative, during the operation of the converter circuit with the one switching group and the n further switching groups, the following steps proceed in terms of the method:
(a) for an adjustable first time period, the first switch is closed and a number of the second switches are closed, wherein the number is less than n and the second switches that have not been closed are opened,
(b) after the adjustable first time period has elapsed, the first switch is opened, the first switch is kept opened, the second switches that were closed under step (a) are opened and the second switches that were closed under step (a) are kept opened,
(c) after the adjustable first time period has elapsed, at least one of the second switches that were opened under step (a) is closed for an adjustable second time period,
(d) after the adjustable second time period has elapsed, the at least one second switch that was closed in step (c) is opened and the at least one second switch that was opened in step (c) is kept opened,
(e) after the adjustable second time period has elapsed, at least one second switch which has not yet been closed previously is closed for the adjustable second time period,
(f) after the adjustable second time period has elapsed, the at least one second switch that was closed in step (e) is opened and the at least one second switch that was opened in step (e) is kept opened,
(g) steps (e) and (f) are repeated until all of the second switches have been closed and opened again once,
(h) steps (a) to (g) are repeated.

By means of this alternative, the voltage value at the second capacitive energy store can advantageously be set in a variable manner, whereby an electrical load connected for example to the second capacitive energy store can likewise be optimally supplied.

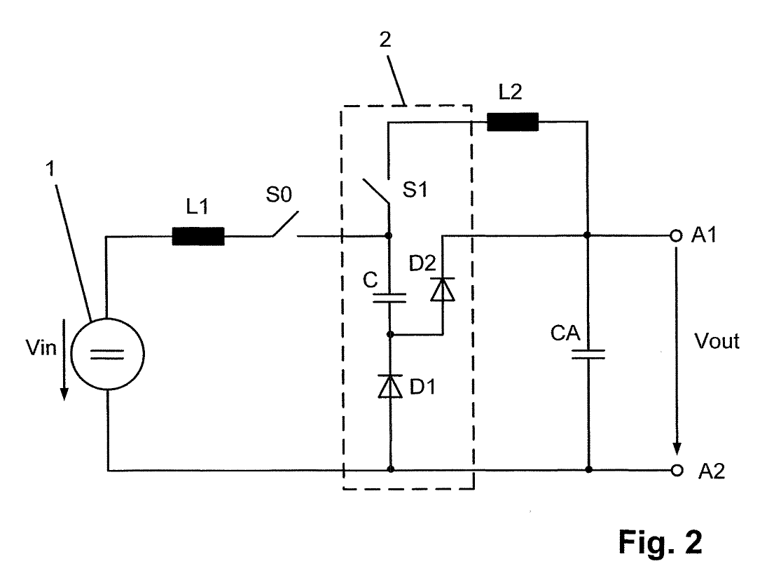

FIG. 2 illustrates a first exemplary embodiment of a converter circuit according to the disclosure. Therein the converter circuit has a DC voltage source 1 and a first switch S0, which is connected to the DC voltage source 1. Furthermore, the converter circuit comprises a switching group 2, which switching group 2 has a second switch S1, a first capacitive energy store C, a first and a second unidirectional non-drivable power semiconductor switch D1, D2. Preferably, the first and the second unidirectional non-drivable power semiconductor switch D1, D2 is embodied as a diode. In accordance with FIG. 2, the second switch S1 is connected to the first capacitive energy store C, the first capacitive energy store C is connected to the first unidirectional non-drivable power semiconductor switch D1, the second unidirectional non-drivable power semiconductor switch D2 is connected to the junction point between the first capacitive energy store C and the first unidirectional non-drivable power semiconductor switch D1 and the first switch S0 is connected to the junction point between the second switch S1 and the first capacitive energy store C. Furthermore, the converter circuit comprises a second capacitive energy store CA, which second capacitive energy store CA is jointly connected to the second switch S1 of the switching group 2 and to the second unidirectional non-drivable power semiconductor switch D2 of the switching group 2. The second capacitive energy store CA is additionally connected to the first unidirectional non-drivable power semiconductor switch D1 of the switching group D2 and the DC voltage source 1 is connected to the junction point between the second capacitive energy store CA and the first unidirectional non-drivable power semiconductor switch D1 of the switching group 2. According to the disclosure, a first inductance L1 is now connected in series into the connection of the DC voltage source 1 to the first switch S0. Furthermore, a second inductance L2 is connected in series into the connection of the second switch S1 of the switching group 2 to the junction point between the second capacitive energy store CA and the second unidirectional non-drivable power semiconductor switch D2 of the switching group 2.

By closing the first switch S0 and opening the second switch S1, the first capacitive energy store C is charged and in this way advantageously virtually no losses arise, since the first inductance L1 together with the first capacitive energy store C forms a resonant circuit having a resonant behavior. Moreover the first capacitive energy store C is charged to double the voltage value Vin of the DC voltage source 1, such that an improved utilization of the first capacitive energy store C can advantageously be achieved. If the first capacitive energy store C is discharged when the first switch S0 is opened and the second switch S1 is closed, then in that case, too, advantageously virtually no losses arise, since the second inductance L2 together with the first capacitive energy store C and the second capacitive energy store CA forms a resonant circuit having a resonant behavior. An electrical load can be connected to the second capacitive energy store CA, e.g., in parallel, wherein the voltage value Vout at the second capacitive energy store CA can be set as follows:

Vout=Vin/2,

that is to say that half the voltage Vin of the DC voltage source 1 is set as voltage value Vout at the second capacitive energy store CA.

Preferably, the value of the first inductance L1 corresponds to the value of the second inductance L2 in the exemplary embodiment of the converter circuit in accordance with FIG. 2.

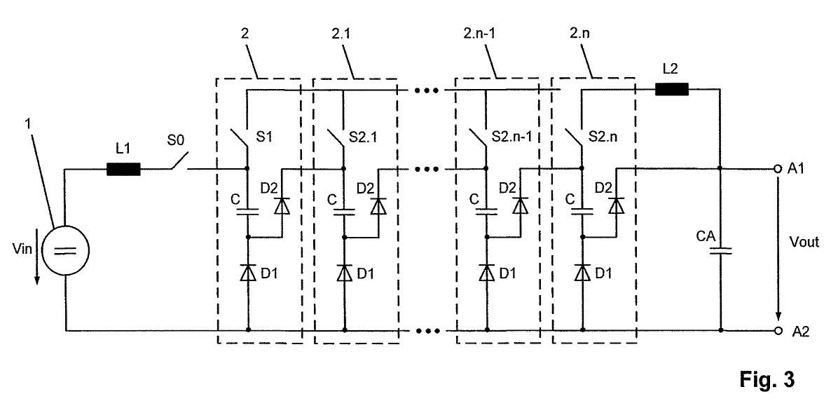

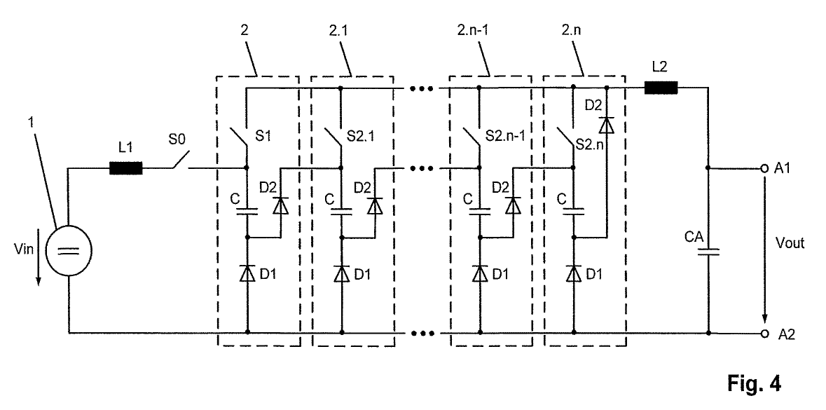

FIG. 3 shows a second exemplary embodiment of a converter circuit according to the disclosure. This alternative converter circuit to FIG. 2 comprises the switching group 2 and additionally n further switching groups 2.1, . . . , 2.n, wherein n≧1 and each switching group 2, 2.1, . . . , 2.n has the second switch S1, S2.1, . . . , S2.n, the first capacitive energy store C, the first and the second unidirectional non-drivable power semiconductor switch D1, D2, wherein the second switch S1, S2.1, . . . , S2.n is connected to the first capacitive energy store C, the first capacitive energy store C is connected to the first unidirectional non-drivable power semiconductor switch D1, the second unidirectional non-drivable power semiconductor switch D2 is connected to the junction point between the first capacitive energy store C and the first unidirectional non-drivable power semiconductor switch D1 and the first switch S0 is connected to the junction point between the second switch S1 and the first capacitive energy store C of the switching group 2. Since, in accordance with FIG. 3, the switching group 2 and the n further switching groups are multipole networks embodied as six-pole networks, in an analogous manner to four-pole theory each of the n further switching groups 2.1, . . . , 2.n is connected in interlinked fashion to the respectively adjacent further switching group 2.1, . . . , 2.n and the switching group 2 is connected in interlinked fashion to the first further switching group 2.1, wherein the first unidirectional non-drivable power semiconductor switches D1 of the switching groups 2, 2.1., . . . , 2.n are connected to one another. The converter circuit furthermore comprises the second capacitive energy store CA, which second capacitive energy store CA is jointly connected to the second switch S2.n of the n-th further switching group 2.n and to the second unidirectional non-drivable power semiconductor switch D2 of the n-th further switching group 2.n, and the second capacitive energy store CA and the DC voltage source 1 are connected to the junction point between the first unidirectional non-drivable power semiconductor switches D1 of the switching groups 2, 2.1, . . . , 2.n. According to the disclosure, in this alternative converter circuit, too, the first inductance L1 is connected in series into the connection of the DC voltage source 1 to the first switch S0. Moreover, now the second inductance L2 is connected in series into the connection of the second switch S2.n of the n-th further switching group 2.n to the junction point between the second capacitive energy store CA and the second unidirectional non-drivable power semiconductor switch D2 of the n-th further switching group 2.n or, in accordance with a third exemplary embodiment of the converter circuit according to the disclosure as shown in FIG. 4, the second inductance L2 is connected in series into the connection of the second capacitive energy store CA to the junction point between the second switch S2.n of the n-th further switching group 2.n and the second unidirectional non-drivable power semiconductor switch D2 of the n-th further switching group 2.n.

By closing the first switch S0 and opening the second switches S1, S2.1, . . . , S2.n of all the switching groups 2, 2.1, . . . , 2.n, the first capacitive energy store C of each switching group 2, 2.1, . . . , 2.n is charged, wherein advantageously virtually no losses arise, since the first inductance L1 together with the first capacitive energy stores C of the switching groups 2, 2.1, . . . , 2.n forms a resonant circuit having a resonant behavior. Moreover, the first capacitive energy stores C are charged to double the voltage value Vin of the DC voltage source 1, such that an improved utilization of the first capacitive energy stores C can advantageously be achieved. If, when the first switch S0 is opened and at least one of the second switches S1, S2.1, . . . , S2.n of the switching groups 2, 2.1, . . . , 2.n is closed, the associated first capacitive energy store C is discharged, then in that case, too, advantageously virtually no losses arise, since the second inductance L2 together with the corresponding first capacitive energy store C and the second capacitive energy store CA or, in the case of a plurality of closed second switches S1, S2.1, . . . , S2.n, with the corresponding first capacitive energy stores C and the second capacitive energy store CA forms a resonant circuit having a resonant behavior. Moreover, by flexibly closing at least one second switch S1, S2.1, . . . , S2.n of the switching groups 2, 2.1, . . . , 2.n, the voltage Vout at the second capacitive energy store CA can advantageously be set, to which second capacitive energy store CA an electrical load can be connected, e.g., in parallel.

In the exemplary embodiments in accordance with FIG. 3 and FIG. 4, the value of the first inductance L1 corresponds to the n-fold value of the second inductance L2, whereby the second inductance L2 can advantageously be chosen to have a value n times smaller than the first inductance L1.

According to the disclosure, with regard to the operation of the converter circuit according to the disclosure in accordance with FIG. 2 with the one switching group 2, the following steps proceed in terms of the method:
(a) for an adjustable first time period t1, the first switch S0 is closed and the second switch S1 is opened,
   whereby it can be ensured that the first capacitive energy store C is charged to double the voltage value Vin of the DC voltage source 1 sufficiently and without appreciable losses,
(b) after the adjustable first time period t1 has elapsed, the first switch S0 is opened for an adjustable second time period t2 and the second switch S1 is closed for the adjustable second time period t2,
   whereby the first capacitive energy store C is discharged to a certain extent via the second inductance L2 depending on the setting of the second time period t2 and the second capacitive energy store CA is charged, and
(c) after the adjustable second time period t2 has elapsed, steps (a) to (b) are repeated.

Overall, what can be achieved by this operation of the converter circuit in accordance with FIG. 2 in a very simple manner is that almost no losses occur and an electrical load connected for example to the second capacitive energy store CA can always be sufficiently supplied with electrical energy and a stable voltage value.

According to the disclosure, with regard to the operation of the converter circuit according to the disclosure in accordance with FIG. 3 and FIG. 4 with the switching group 2 and the n further switching groups 2.1, . . . , 2.n, the following steps proceed in terms of the method:
(a) for an adjustable first time period t1, the first switch S0 is closed and the second switches S1, S2.1, . . . , S2.n are opened,
   whereby it can advantageously be ensured that all of the first capacitive energy stores C of the switching groups 2, 2.1, . . . , 2.n are charged to double the voltage value Vin of the DC voltage source 1 sufficiently and without appreciable losses.
(b) after the adjustable first time period t1 has elapsed, the first switch S0 is opened and the first switch S0 is kept opened,
(c) after the adjustable first time period t1 has elapsed, at least one of the second switches S1, S2.1, . . . , S2.n is closed for an adjustable second time period t2,
(d) after the adjustable second time period t2 has elapsed, the at least one second switch S1, S2.1, . . . , S2.n that was closed in step (c) is opened and the at least one second switch S1, 2.1, . . . , S2.n that was opened in step (c) is kept opened,
(e) after the adjustable second time period t2 has elapsed, at least one second switch S1, S2.1, . . . , S2.n which has not yet been closed previously is closed for the adjustable second time period t2,
(f) after the adjustable second time period t2 has elapsed, the at least one second switch S1, S2.1, . . . , S2.n that was closed in step (e) is opened and the at least one second switch S1, S2.1, . . . , S2.n that was opened in step (e) is kept opened,
(g) steps (e) and (f) are repeated until all of the second switches S1, S2.1, . . . , S2.n have been closed and opened again once,
(h) steps (a) to (g) are repeated.

By closing at least one of the second switches, the first capacitive energy store C or the first capacitive energy stores C is or are discharged to a certain extent via the second inductance L2 depending on the setting of the second time period t2 and the second capacitive energy store CA is charged. Furthermore, by means of the above-described flexible closing of at least one second switch S1, S2.1, . . . , S2.n of the switching groups 2, 2.1, . . . , 2.n, it is advantageously possible to set the voltage Vout at the second capacitive energy store CA and thus optimally supply an electrical load connected for example to the second capacitive energy store CA.

If the above-described method for operating the converter circuit according to the disclosure as shown in FIG. 3 and FIG. 4, with regard to steps (c) to (g), is carried out precisely for always one second switch S1, S2.1, . . . , S2.n instead of for at least one second switch S1, S2.1, . . . , S2.n, then the voltage value Vout at the second capacitive energy store CA is advantageously set as follows:

Vout=Vin/(n+2),

that is to say that, for example for n=3 further switching groups 2.1, 2.2, 2.3, one fifth of the voltage value Vin of the DC voltage source 1 is set as voltage value Vout at the second capacitive energy store CA.

As an alternative, with regard to the operation of the converter circuit according to the disclosure in accordance with FIG. 3 and FIG. 4 with the switching group 2 and the n further switching groups 2.1, . . . , 2.n, the following steps proceed in terms of the method:
(a) for an adjustable first time period t1, the first switch S0 is closed and a number of the second switches S1, S2.1, . . . , S2.n are closed, wherein the number is less than n and the second switches S1, S2.1, . . . , S2.n that have not been closed are opened,
(b) after the adjustable first time period t1 has elapsed, the first switch S0 is opened, the first switch S0 is kept opened, the second switches S1, S2.1, . . . , S2.n that were closed under step (a) are opened and the second switches S1, S2.1, . . . , S2.n that were closed under step (a) are kept opened,
(c) after the adjustable first time period t1 has elapsed, at least one of the second switches S1, S2.1, . . . , S2.n that were opened under step (a) is closed for an adjustable second time period t2,
(d) after the adjustable second time period t2 has elapsed, the at least one second switch S1, S2.1, . . . , S2.n that was closed in step (c) is opened and the at least one second switch S1, 2.1, . . . , S2.n that was opened in step (c) is kept opened,
(e) after the adjustable second time period t2 has elapsed, at least one second switch S1, S2.1, . . . , S2.n which has not yet been closed previously is closed for the adjustable second time period t2,
(f) after the adjustable second time period t2 has elapsed, the at least one second switch S1, S2.1, . . . , S2.n that was closed in step (e) is opened and the at least one second switch S1, S2.1, . . . , S2.n that was opened in step (e) is kept opened,
(g) steps (e) and (f) are repeated until all of the second switches S1, S2.1, . . . , S2.n have been closed and opened again once,
(h) steps (a) to (g) are repeated.

By means of this alternative, the voltage value Vout at the second capacitive energy store CA can advantageously be set in a variable manner.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 DC voltage source
2 Switch group
2.1, . . . ,2.n n further switching groups
S0 First switch
S1 Second switch of the switching group
S2.1, . . . ,S2.n Second switches of the n further switching groups
C First capacitive energy store of the switching group and of the n further switching groups
D1 First unidirectional non-drivable power semiconductor switch of the switching group and of the n further switching groups
D2 Second unidirectional non-drivable power semiconductor switch of the switching group and of the n further switching groups
L1 First inductance
L2 Second inductance
CA Second capacitive energy store
A1, A2 Load terminals

What is claimed is:

1. A converter circuit having a DC voltage source,
having a first switch, which is connected to the DC voltage source,
having a switching group, which switching group has a second switch, a first capacitive energy store, a first and a second unidirectional non-drivable power semiconductor switch, wherein the second switch is connected to the first capacitive energy store, the first capacitive energy store is connected to the first unidirectional non-drivable power semiconductor switch, the second unidirectional non-drivable power semiconductor switch is connected to the junction point between the first capacitive energy store and the first unidirectional non-drivable power semiconductor switch and the first switch is connected to the junction point between the second switch and the first capacitive energy store,
having a second capacitive energy store, which second capacitive energy store is connected jointly to the second switch of the switching group and to the second unidirectional non-drivable power semiconductor switching of the switching group, the second capacitive energy store is connected to the first unidirectional non-drivable power semiconductor switch of the switching group and the DC voltage source is connected to the junction point between the second capacitive energy store and the first unidirectional non-drivable power semiconductor switch of the switching group,
wherein a first inductance is connected in series into the connection of the DC voltage source to the first switch, and
wherein a second inductance is connected in series into the connection of the second switch of the switching group to the junction point between the second capacitive energy store and the second unidirectional non-drivable power semiconductor switch of the switching group.

2. A converter circuit having a DC voltage source,
having a first switch, which is connected to the DC voltage source,
having a switching group and n further switching groups, wherein n≧1 and each switching group has a second switching, a first capacitive energy store, a first and a second unidirectional non-drivable power semiconductor switch, wherein the second switch is connected to the first capacitive energy store, the first capacitive energy store is connected to the first unidirectional non-drivable power semiconductor switch, the second unidirectional non-drivable power semiconductor switch is connected to the junction point between the first capacitive energy store and the first unidirectional non-drivable power semiconductor switch, the first switch is connected to the junction point between the second switch and the first capacitive energy store of the switching group each of the n further switching groups is connected in interlinked fashion to the respectively adjacent further switching group and the switching group is connected in interlinked fashion to the first further switching group, wherein the first unidirectional non-drivable power semiconductor switches of the switching groups are connected to one another,
having a second capacitive energy store, which second capacitive energy store is jointly connected to the second switch of the n-th further switching group and to the second unidirectional non-drivable power semiconductor switch of the n-th further switching group, the second capacitive energy store and the DC voltage source are connected to the junction point between the first unidirectional non-drivable power semiconductor switches of the switching groups,
wherein a first inductance is connected in series into the connection of the DC voltage source to the first switch, and
wherein a second inductance is connected in series into the connection of the second switch of the n-th further switching group to the junction point between the second capacitive energy store and the second unidirectional non-drivable power semiconductor switch of the n-th further switching group.

3. A converter circuit having a DC voltage source,
having a first switch, which is connected to the DC voltage source,
having a switching group and n further switching groups, wherein n≧1 and each switching group has a second switch, a first capacitive energy store, a first and a second unidirectional non-drivable power semiconductor switch, wherein the second switch is connected to the first capacitive energy store, the first capacitive energy store is connected to the first unidirectional non-drivable power semiconductor switch, the second unidirectional non-drivable power semiconductor switch is connected to the junction point between the first capacitive energy store and the first unidirectional non-drivable power semiconductor switch, the first switch is connected to the junction point between the second switch and the first capacitive energy store of the switching group, each of the n further switching groups is connected in interlinked fashion to the respectively adjacent further switching group and the switching group is connected in interlinked fashion to the first further switching group, wherein the first unidirectional non-drivable power semiconductor switches of the switching groups are connected to one another,
having a second capacitive energy store, which second capacitive energy store is jointly connected to the second switch of the n-th further switching group and to the second unidirectional non-drivable power semiconductor switch of the n-th further switching group, the second capacitive energy store and the DC voltage source are connected to the junction point between the first unidirectional non-drivable power semiconductor switches of the switching groups,
wherein a first inductance is connected in series into the connection of the DC voltage source to the first switch, and
wherein a second inductance is connected in series into the connection of the second capacitive energy store to the junction point between the second switch of the n-th further switching group and the second unidirectional non-drivable power semiconductor switch of the n-th further switching group.

4. The converter circuit as claimed in claim 1, wherein the value of the first inductance corresponds to the value of the second inductance.

5. The converter circuit as claimed in claim 2, wherein the value of the first inductance corresponds to the n-fold value of the second inductance.

6. A method for operating the converter circuit as claimed in claim 1, comprising the following steps:
(a) for an adjustable first time period (t1), the first switch is closed and the second switch is opened,
(b) after the adjustable first time period has elapsed, the first switch is opened for an adjustable second time period and the second switch is closed for the adjustable second time period, and
(c) after the adjustable second time period has elapsed, steps (a) and (b) are repeated.

7. A method for operating the converter circuit as claimed in claim 2, comprising the following steps:
(a) for an adjustable first time period, the first switch is closed and the second switches are opened,
(b) after the adjustable first time period has elapsed, the first switch is opened and the first switch is kept opened,
(c) after the adjustable first time period has elapsed, at least one of the second switches is closed for an adjustable second time period,
(d) after the adjustable second time period has elapsed, the at least one second switch that was closed in step (c) is opened and the at least one second switch that was opened in step (c) is kept opened,
(e) after the adjustable second time period has elapsed, at least one second switch which has not yet been closed previously is closed for the adjustable second time period,
(f) after the adjustable second time period has elapsed, the at least one second switch that was closed in step (e) is opened and the at least one second switch that was opened in step (e) is kept opened,
(g) steps (e) and (f) are repeated until all of the second switches have been closed and opened again once,
(h) steps (a) to (g) are repeated.

8. A method for operating the converter circuit as claimed in claim 2, comprising the following steps:
(a) for an adjustable first time period, the first switch is closed and a number of the second switches are closed, wherein the number is less than n and the second switches that have not been closed are opened,
(b) after the adjustable first time period has elapsed, the first switch is opened, the first switch is kept opened, the second switches that were closed under step (a) are opened and the second switches that were closed under step (a) are kept opened,
(c) after the adjustable first time period has elapsed, at least one of the second switches that were opened under step (a) is closed for an adjustable second time period,
(d) after the adjustable second time period has elapsed, the at least one second switch that was closed in step (c) is opened and the at least one second switch that was opened in step (c) is kept opened,
(e) after the adjustable second time period has elapsed, at least one second switch which has not yet been closed previously is closed for the adjustable second time period,
(f) after the adjustable second time period has elapsed, the at least one second switch that was closed in step (e) is opened and the at least one second switch that was opened in step (e) is kept opened,
(g) steps (e) and (f) are repeated until all of the second switches have been closed and opened again once,
(h) steps (a) to (g) are repeated.

9. The converter circuit as claimed in claim 3, wherein the value of the first inductance corresponds to the n-fold value of the second inductance.

10. A method for operating the converter circuit as claimed in claim 3, comprising the following steps:
(a) for an adjustable first time period, the first switch is closed and the second switches are opened,
(b) after the adjustable first time period has elapsed, the first switch is opened and the first switch is kept opened,
(c) after the adjustable first time period has elapsed, at least one of the second switches is closed for an adjustable second time period,
(d) after the adjustable second time period has elapsed, the at least one second switch that was closed in step (c) is opened and the at least one second switch that was opened in step (c) is kept opened,
(e) after the adjustable second time period has elapsed, at least one second switch which has not yet been closed previously is closed for the adjustable second time period,
(f) after the adjustable second time period has elapsed, the at least one second switch that was closed in step (e) is opened and the at least one second switch that was opened in step (e) is kept opened,
(g) steps (e) and (f) are repeated until all of the second switches have been closed and opened again once,
(h) steps (a) to (g) are repeated.

11. A method for operating a converter circuit as claimed in claim 3, comprising the following steps:
(a) for an adjustable first time period, the first switch is closed and a number of the second switches are closed, wherein the number is less than n and the second switches that have not been closed are opened,
(b) after the adjustable first time period has elapsed, the first switch is opened, the first switch is kept opened, the second switches that were closed under step (a) are opened and the second switches that were closed under step (a) are kept opened,
(c) after the adjustable first time period has elapsed, at least one of the second switches that were opened under step (a) is closed for an adjustable second time period,
(d) after the adjustable second time period has elapsed, the at least one second switch that was closed in step (c) is opened and the at least one second switch that was opened in step (c) is kept opened,
(e) after the adjustable second time period has elapsed, at least one second switch which has not yet been closed previously is closed for the adjustable second time period,
(f) after the adjustable second time period has elapsed, the at least one second switch that was closed in step (e) is opened and the at least one second switch that was opened in step (e) is kept opened,
(g) steps (e) and (f) are repeated until all of the second switches have been closed and opened again once,
(h) steps (a) to (g) are repeated.

12. A converter circuit having a DC voltage source, comprising:
a first switch of the converter circuit;
a first inductance connected in series into a connection of the DC voltage source of the converter circuit to the first switch of the converter circuit;
a switching group of the converter circuit having a second switch, a second capacitive energy store, and a second unidirectional non-drivable power semiconductor switch; and
a second inductance connected in series into a connection of the second switch of the switching group of the converter circuit to a junction point between the second capacitive energy store and the second unidirectional non-drivable power semiconductor switch of the switching group.
